(19) United States
(12) Patent Application Publication
(10) Pub. No.: US 2007/0183592 A1
(43) Pub. Date: Aug. 9, 2007

(54) Method And Apparatus For Inconspicuous Audio Notification

(76) Inventors: David W. Boyd, Greeley, CO (US); Steven L. Webb, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/696,465

(22) Filed: Apr. 4, 2007

Related U.S. Application Data
(63) Continuation of application No. 10/326,322, filed on Dec. 20, 2002.

(51) Int. Cl. H04M 1/00

(52) U.S. Cl. 379/373.02

(57) ABSTRACT

A portable device that produces inconspicuous sounds for event notification is disclosed. One type of inconspicuous sound is a sound that the human body makes in response to an involuntary bodily function. For example, the portable device could produce the sound of a cough to alert the user of an event. Other types of inconspicuous sounds are sounds that are commonly heard in the environment. For example, when in a restaurant the sound of clinking glasses is a common sound.

### PARENT APPLICATION

This application is a continuation under 37 C.F.R. § 1.53(b) of application Ser. No. 10/326,322 filed on Dec. 20, 2002, which is hereby incorporated by reference.

### FIELD OF THE INVENTION

The field of this invention relates to portable devices and more specifically to a portable device that produces an inconspicuous sound for event notification.

### BACKGROUND OF THE INVENTION

Portable devices are becoming more common. There are many types of portable devices; one example is a PDA (personal digital assistant). Probably the most common type of portable device is the cell phone. As these devices become more common, the problem of having them make sounds in an inappropriate place has also become more common. Cell phones have addressed this problem in a number of ways.

One way to notify the user of an incoming call is to vibrate instead of making an audible sound. This method is ineffective when the device is in a purse or jacket pocket and not on the user's person.

Other phones allow the user to disable the sound during preset times during the day. For example, a user may have a meeting from 2:00 to 4:00 every day. The user would program their phone not to ring during this time. Yet other phones have GPS (Global Positioning Systems) systems and allow the user to disable the rings at certain geographic locations. For example, a user may disable the ring when the phone is located at a movie theater. A User could also just turn there phone off, but it's easy to forget to turn the phone off. Unfortunately when the phones are disabled the user may miss an important call.

Therefore there is a need for a portable device that can notify the user of events in an inconspicuous manner.

### SUMMARY OF THE INVENTION

A portable device that produces inconspicuous sounds for event notification is disclosed. One type of inconspicuous sound is a sound that the human body makes in response to an involuntary bodily function. For example, the portable device could produce the sound of a cough to alert the user of an event. Other types of inconspicuous sounds are sounds that are commonly heard in the environment. For example, when in a restaurant the sound of clinking glasses is a common sound.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a block diagram of a portable device in accordance with an example embodiment of the present invention.

FIG. 2 is a flow chart for the selection of an inconspicuous sound in accordance with an example embodiment of the present invention.

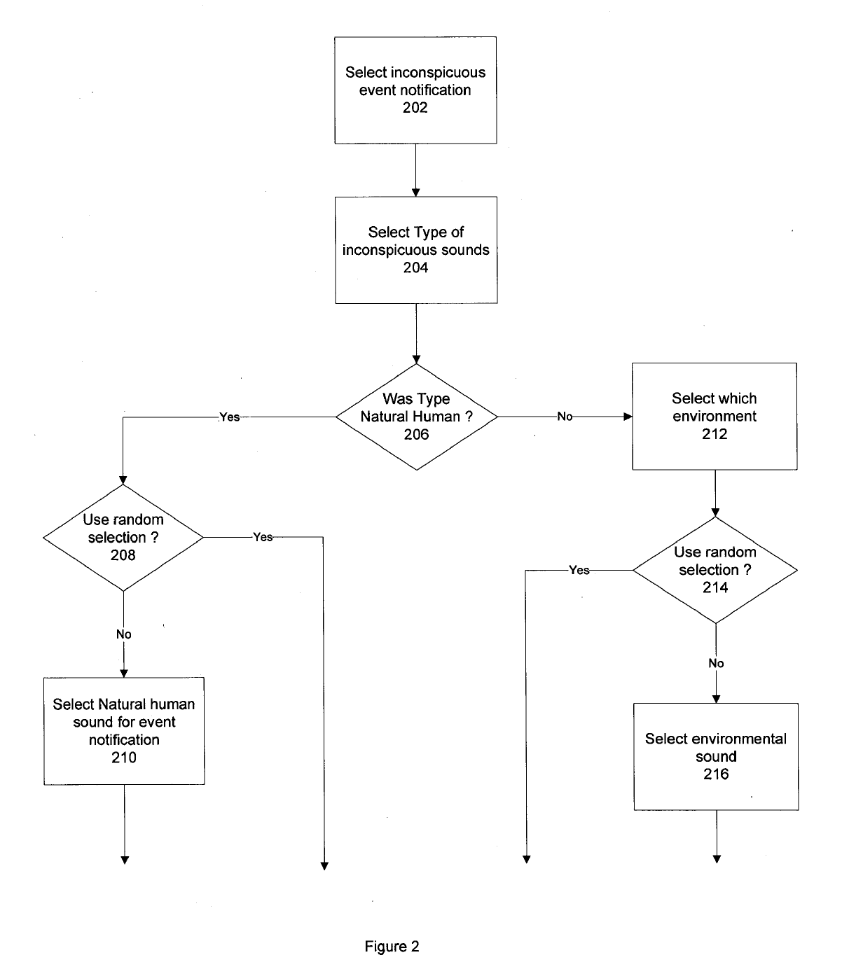

### DETAILED DESCRIPTION OF THE PREFERRED EMBODIMENT

A portable device that can notify a user of an event using an inconspicuous sound may reduce the disruption caused by the notification.

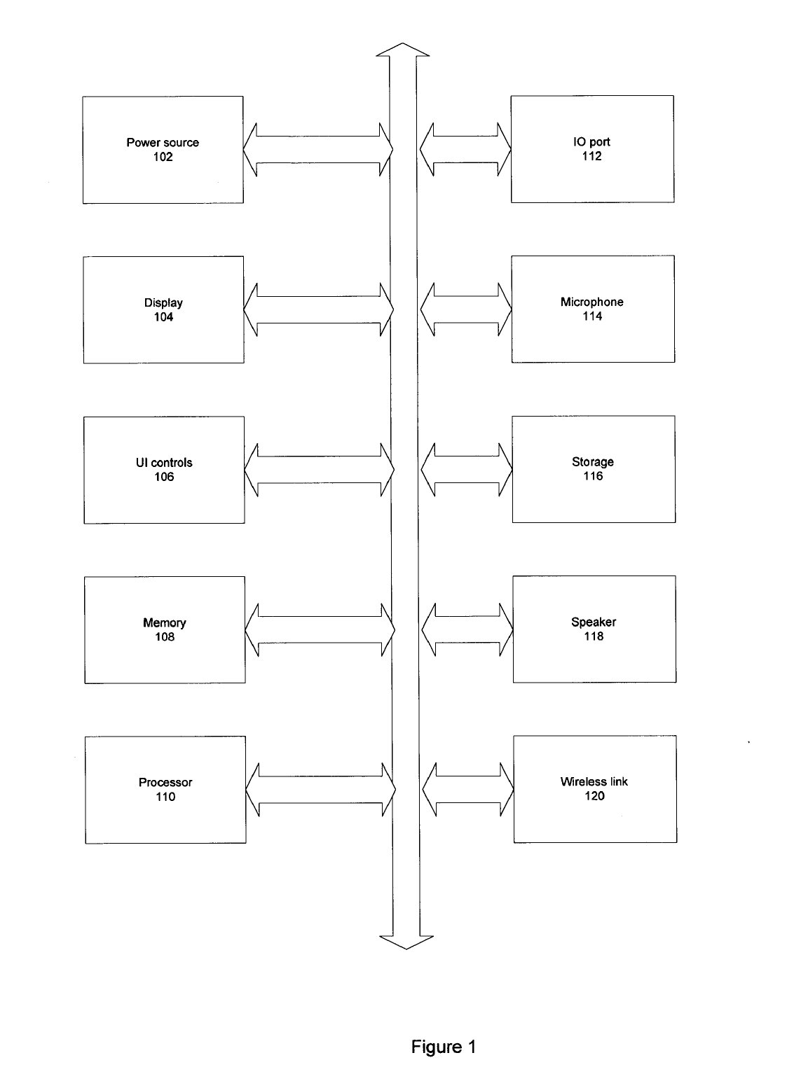

A block diagram of a typical portable device is shown in FIG. 1. The portable device contains a processor (110), memory (108), storage (116), a user input (UI) control (typically a keypad or keyboard 106), a power source (typically a battery 102), and a speaker (118). The device may also contain a display (104), a microphone (114), an input/output (10) port (112), and a wireless link (120). The storage is used to non-volatilely store the inconspicuous sounds. The processor moves the sounds from storage and plays them on the speaker.

Because the portable device is typically with a person, one type of inconspicuous sound is a natural human sound. For this application, a natural human sound will be defined as a sound that the human body makes in response to an involuntary bodily function. Some examples of natural human sounds are: coughs, hiccups, sneezes, yawns, burps, flatus (commonly called breaking wind), and groans. People have some control over some of these sounds, but each sound is in response to an involuntary bodily function. For example, people can suppress a burp, but the underlying cause of the burp is excess gas in the stomach.

Another type of sound that is inconspicuous is a sound that occurs naturally in the environment. When the portable device is located at a restaurant, sounds that you would normally hear at a restaurant would be inconspicuous. For example, sounds you normally hear at a restaurant might include the clinking of glasses, the click of silverware, the popping of a wine cork, and the sound of water being poured into a glass. Many environments have characteristic sounds. A sporting event has the sound of cheers, whistles, clapping, and the sounds from the scoreboard. Movies have the sound of popcorn being eaten, the ripping of a bag of candy being opened, and the creaking of chairs. A business meeting has the sound of rustling paper, the closing of a brief case, and the creaking of chairs.

Sounds can be stored in a number of ways. Sounds can be stored as an analog signal, for example a tape recording. Today in portable devices, sounds are typically digitized and stored as a digital file. Older portable devices only have the capacity to play files that contain single tones or polyphonic sounds. This limited the flexibility of the sounds they could generate. Newer portable devices can play XMF (extensible Music Format) files. These files can contain their own custom samples, which can be any type of recording. Some portable devices can play WAV, MIDI, AIFF (Audio Interchange File Format) or MP3 files. These file types also allow any type of sound to be recorded. The sounds can come pre-recorded on the device, or the sounds can be downloaded into the device by the user, for example from a web site. Some phones can record sounds to use as ring tones. A user could record the sound of his own cough to use as a ring tone.

In one example embodiment of the current invention the portable device would allow the user to select an option for inconspicuous sounds for event notification. When the device was in the inconspicuous notification mode, the device would notify the user of an event by generating a natural human sound. The event could be, but is not limited to, an incoming call, the expiration of a timer, or the completion of a program. In one example embodiment the user could select a natural human sound from a list of natural sounds. In another embodiment the device would randomly choose a natural human sound. In another embodiment the user could select a plurality of natural human sounds and the device would randomly choose one of the sounds selected from the plurality of sounds the user had designated. In another example embodiment of the current invention, the list of natural human sounds would be included in the list of sounds used for event notification. The user would not need to enter a special inconspicuous mode, the user would simply select one of the inconspicuous sounds for event notification.

In another embodiment of the current invention, the user would select an inconspicuous sound based on an environment, for example a restaurant. The user would select an environment from a list of environments. Once an environment had been selected, the portable device would notify the user of an event using a sound characteristically found in that environment. In one example embodiment, the device would randomly choose a sound, from the sounds found in the environment, to notify the user of an event. In another embodiment, the user could select a sound from a plurality of characteristic sounds found in the selected environment. In another example embodiment of the current invention, the list of environmental sounds would be included in the list of sounds used for event notification. The user would not need to enter a special inconspicuous mode, the user would simply select one of the inconspicuous sounds for event notification.

In one example embodiment of the current invention, the user would be allowed to create a custom environment. The user would choose a name for the custom environment and then choose a number of sounds characteristically found in that environment. The sounds chosen by the user could be downloaded into the device or selected from the sounds already contained in the device. For example, if the user commonly went to a pet show. The user may create a pet show environment that contained the sound of dogs barking, cats meowing, and birds singing.

In another example embodiment of the current invention, the device would contain both the natural human sounds and the environmental location sounds. The user could select just the natural human sounds or one of the sets of environmental sounds. Or the user could combine the natural human sounds with one of the sets of environmental sounds.

In another example embodiment of the current invention, the user would select an inconspicuous mode (202). The user would then choose the type of inconspicuous sound (204). When a user selects a natural human sound, the user then chooses (208) if the natural human sound should be randomly selected or if the user should select a natural human sound (210). When the user does not choose a natural human sound in step 204, the user selects the predetermined environment (212). Once the environment has been determined, the user decides if the inconspicuous sound should be randomly selected or if the user should select the environmental sound (216).

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method, comprising:
selecting an inconspicuous sound that is a natural human sound; and
producing the inconspicuous sound in response to an event.

2. A method comprising:
selecting an inconspicuous sound that is a sound normally occurring in a predetermined environment; and
producing the inconspicuous sound in response to an event.

3. The method of claim 2 where the predetermined environment is a movie theater.

4. The method of claim 2 where the predetermined environment is a business meeting.

5. The method of claim 2 where the predetermined environment is a restaurant.

6. A method comprising:
producing a sound that mimics a natural human sound to alert a user to an event.

7. The method of claim 6 where the sound is a cough.

8. The method of claim 6 where the sound is a burp.

9. The method of claim 6 where the sound is a sneeze.

10. The method of claim 6 where the sound is a hiccup.

11. The method of claim 6 where the sound is a flatus.

12. The method of claim 6 where the event is an incoming call.

13. The method of claim 6 where the sound is produced electronically.
